(19) United States
(12) Patent Application Publication
(10) Pub. No.: US 2011/0194374 A1
(43) Pub. Date: Aug. 11, 2011

(54) STIRRING, EMULSIFYING AND SMALL MOLECULE CLUSTERING APPARATUS FOR PRODUCING OIL-WATER FUEL

(76) Inventor: Hung-Lieh Chen, Taipei (TW)

(21) Appl. No.: 12/702,572

(22) Filed: Feb. 9, 2010

(51) Int. Cl. B01F 15/00

(52) U.S. Cl. 366/165.3

(57) ABSTRACT

An apparatus is used to stir and mix water with oil and simultaneously form small water-in-oil molecular clusters in the process of producing emulsion fuel. The apparatus includes a stirring tank and a stirring device located in the tank. The stirring device includes a rotary shaft and at least two axially extended blades connected to the rotary shaft. The blades respectively have a plurality of evenly distributed perforations formed thereon. When the blades rotate, the water and oil in the tank are continuously cut due to the perforations to thereby become evenly mixed with each other. Tourmaline stones or other power stones, collectively referred to as the tourmaline stones herein, are positioned in the stirring tank to electrolyze the water and form small water molecular clusters. The tourmaline stones also cause the water to contain rich amount of anionic surfactants, which emulsify the oil-water fuel to thereby form emulsion fuel.

### FIELD OF THE INVENTION

The present invention relates to a stirring, emulsifying and small molecule clustering apparatus for producing oil-water fuel. With the apparatus, even stirring, small molecule clustering, and emulsifying in producing oil-water fuel can be done at the same time, so that the production equipment for oil-water emulsion fuel is simplified while the productivity is increased. The apparatus can be applied to gasoline, diesel oil, boiler oil, and heavy oil.

### BACKGROUND OF THE INVENTION

Boilers for industrial purpose usually use heavy oil as the fuel thereof. Heavy oil is produced after many stages of fractional distillation of crude oil. Heavy oil has the disadvantages of high burning point and not uneasily completely combustible. When a fuel containing only heavy oil is burnt, a large volume of emissions, such as carbon monoxide (CO), nitrogen oxides (NOₓ), etc., is generated into ambient air. These emissions are the so-called black smoke and will cause air pollution.

To solve the problem of incomplete combustion of heavy oil, it has been tried to mix heavy oil with water and add an emulsifier to the oil-water mixture, and evenly stir the mixture into an emulsified state to thereby form an emulsion fuel and small molecular clusters. By doing these, hydrogen and oxygen in water molecules can upgrade the emulsification and oxygen affinity of the fuel, enabling the fuel to burn completely.

Conventionally, a disadvantage of using an emulsifier to form the emulsion fuel is that toxic gas, such as NOₓ, will be generated when the emulsion fuel is burnt to a temperature ranged between 650° C. and 850° C. Currently, a burning facility using an emulsion fuel oil as the fuel thereof is provided with a stirring device and a high-pressure emulsifying device. The stirring device works to stir and accordingly mix oil with water. The high-pressure emulsifying device works to emulsify the oil-water mixture under high pressure, so that water particles of 3 μm˜5 μm can disperse in the fuel oil to form water-in-oil emulsion fuel or oil-in water emulsion fuel. The emulsion fuel produced with the high-pressure emulsifying device contains water molecules of relatively large volume, which brings the emulsion fuel to have lower stability and the oil and water in the emulsion fuel tend to separate from each other to result in unstable and incomplete burning. In some cases, the condition of instantaneous complete combustion similar to explosion will occur to cause danger in the process of burning.

In view of the relatively low fuel quality and low combustion stability of the currently available oil-water emulsion fuel, and the emission of toxic gas NOₓ by the added emulsifier, it is therefore tried by the inventor to develop a stirring, emulsifying, and small molecule clustering apparatus for producing oil-water fuel, so that stirring, emulsifying, and small molecule clustering are completed at one time in producing the oil-water emulsion fuel, and the emulsion fuel so produced does not release any toxic gas, has high combustion stability, and can release even higher heat energy.

### SUMMARY OF THE INVENTION

A primary object of the present invention is to provide a stirring, emulsifying, and small molecule clustering apparatus, which enables stirring, emulsifying, and small molecule clustering to be done at one time in the process of producing oil-water emulsion fuel, so that the production equipment for oil-water emulsion fuel is simplified while the productivity is increased.

Another object of the present invention is to provide a stirring, emulsifying, and small molecule clustering apparatus for producing oil-water fuel, which includes a plurality of tourmaline stones capable of releasing a small amount of electric current. The electric current released by the tourmaline stones causes water to electrolyze and generate water containing hydrogen and oxygen, so that the volume of water molecules is reduced to further enable reduction of the volume of the oil-in-water or the water-in-oil molecules in the emulsion fuel. With the volume-reduced oil-water molecules, more stable and safer combustion of the emulsion fuel can be ensured.

A further object of the present invention is to provide a stirring, emulsifying, and small molecule clustering apparatus for producing oil-water fuel, so that water molecules in the produced oil-water fuel with small molecular clusters contain a small amount of hydrogen and oxygen, which enable the oil-water fuel with small molecular clusters to generate even higher combustion heat during burning.

The stirring, emulsifying, and small molecule clustering apparatus for producing oil-water fuel according to the present invention is mainly characterized by achieving emulsification and forming small molecular clusters while stirring and mixing water with oil, so as to form water-in-oil or oil-in-water emulsion fuel. The apparatus includes a stirring tank, a tourmaline unit, a stirring device, and a motor device. The stirring tank is used to hold oil and water therein for mixing. The stirring device is located in the stirring tank for stirring and mixing the oil with water. The motor device provides power needed by the stirring device to operate. The stirring device includes a rotary shaft and at least two axially extended blades connected to the rotary shaft. The blades are provided with evenly distributed. When the blades rotate along with the rotary shaft to stir the water and oil in the stirring tank, the water and oil are continuously cut due to the perforations to thereby evenly mix with each other.

In the stirring, emulsifying, and small molecule clustering apparatus for producing oil-water fuel according to the present invention, the tourmaline unit can be arranged in the stirring tank or in a water inlet pipeline connected to the stirring tank. The tourmaline unit includes a plurality of stones capable of releasing a small amount of electric current, including tourmaline stones, power stones, or other similar stones, causing part of water molecules to electrolyze. Therefore, the produced oil-water fuel with small molecular clusters contains a small amount of hydrogen and oxygen. The electrolysis of water also enables reduced volume of water molecules to thereby reduce the volume of the oil-in-water or water-in-oil molecules in the emulsion fuel, ensuring more stable and safer combustion of the oil-water fuel.

In the stirring, emulsifying, and small molecule clustering apparatus for producing oil-water fuel according to the present invention, since the tourmaline unit keeps releasing electrons, the water in the stirring tank contains rich anionic surfactants, which emulsify the oil-water mixture to produce the oil-water emulsion fuel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a structural view of a stirring, emulsifying and small molecule clustering apparatus for producing oil-water fuel according to a first embodiment of the present invention;

FIG. 2 is a cross sectional view taken along line 2-2 of FIG. 1;

FIG. 3 is an enlarged fragmentary perspective view showing the blades for a stirring device included in the apparatus of the present invention;

FIG. 4 is a structural view of a stirring, emulsifying and small molecule clustering apparatus for producing oil-water fuel according to a second embodiment of the present invention;

FIG. 5 is a structural view of a stirring, emulsifying and small molecule clustering apparatus for producing oil-water fuel according to a third embodiment of the present invention; and

FIG. 6 shows the apparatus of FIG. 5 with a tourmaline unit thereof provided in another form.

### DETAILED DESCRIPTION OF THE PREFERRED EMBODIMENTS

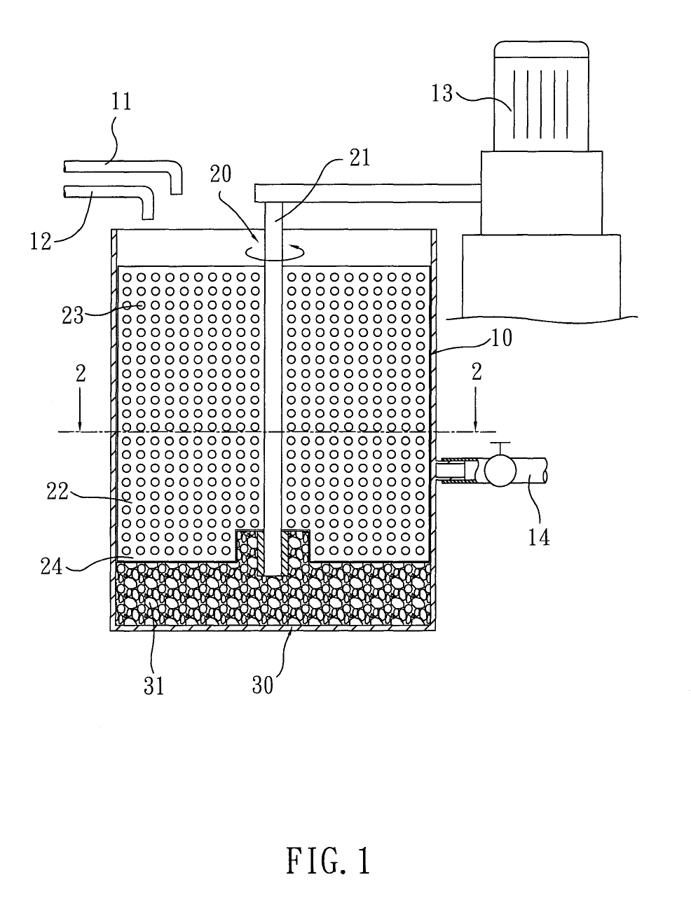

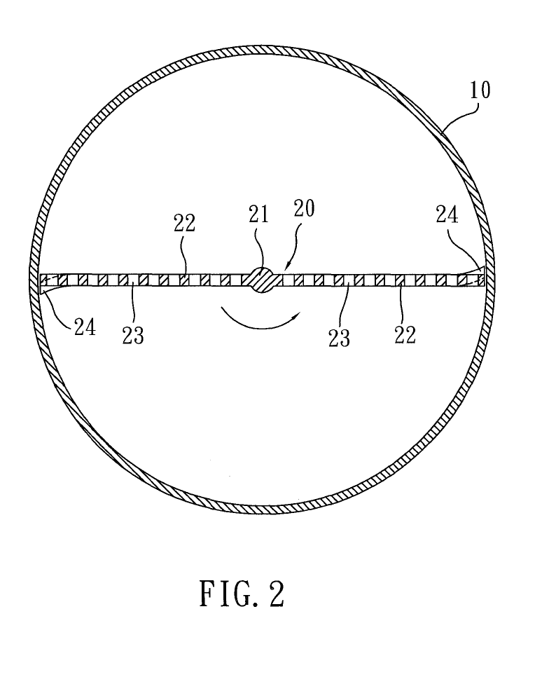

Please refer to FIGS. 1 and 2. A stirring, emulsifying and small molecule clustering apparatus for producing oil-water fuel according to a first embodiment of the present invention is mainly characterized in that stirring, emulsifying, and small molecule clustering can be done at the same time in mixing oil with water, so as to form water-in-oil or oil-in-water emulsion fuel with small molecular clusters. The apparatus in the first embodiment of the present invention includes a stirring tank 10, a stirring device 20, a tourmaline unit 30, and a motor device 13. The stirring tank 10 is used to hold an oil-water mixture therein; the stirring device 20 is used to stir the oil-water mixture in the stirring tank 10; the motor device 13 provides the power needed by the stirring device 20 to operate; and the tourmaline unit 30 includes a plurality of tourmaline stones 31 capable of releasing a small amount of electric current.

The stirring tank 10 is a cylindrical tank. An oil inlet pipeline 11 and a water inlet pipeline 12 are connected to a top of the stirring tank 10 for supplying oil and water into the stirring tank 10. At least one oil-water fuel output pipeline is connected to a predetermined position on a body of the stirring tank 10. The tourmaline unit 30 is arranged in the stirring tank 10 on a bottom thereof. Preferably, the tourmaline unit 30 is immovably fixed to the bottom of the stirring tank 10 using cement.

The stirring device 20 is located in the stirring tank 10, and includes a rotary shaft 21 and at least two axially extended blades 22 connected to the rotary shaft 21. In the illustrated first embodiment, two blades 22 are provided to angularly space from each other by 180 degrees. Each of the blades 22 is formed with a plurality of perforations 23, and the perforations 23 are evenly distributed on the whole area of the blades 22.

The motor device 13 drives the rotary shaft 21 of the stirring device 20 to rotate, and the blades 22 connected to the rotary shaft 21 are brought to stir the oil-water mixture in the stirring tank 10. In the process of stirring, the oil-water mixture is evenly mixed to produce an oil-water fuel. As a result of being continuously cut due to the perforations 23 on the blades 22, the water and oil are fully and evenly mixed to form a water-in-oil fuel or an oil-in-water fuel.

The tourmaline stones 31 in the stirring tank 10 will continuously release a small amount of electric current to electrolyze part of water molecules in the stirring tank 10 to generate hydrogen and oxygen. Therefore, water-in-oil molecules or oil-in-water molecules in the oil-water mixture contain some amount of hydrogen and oxygen. Since part of the water molecules are electrolyzed into hydrogen and oxygen, the volume of water molecules is reduced, which correspondingly results in the reduction of the volume of the water-in-oil molecules in the produced oil-water fuel, allowing the oil-water fuel to be more stably and more completely burnt. Further, since the tourmaline stones 31 will continuously release electrons, there would be anionic surfactants contained in the water molecules. Anionic surfactants can serve as an emulsifier to emulsify the oil-water fuel, so that the oil-water fuel forms an emulsion fuel.

When the emulsion fuel is burnt, the small amount of hydrogen contained in the emulsion fuel will burn at the same time, and the small amount of oxygen contained in the emulsion fuel supports the combustion of the emulsion fuel, so that higher amount of heat is released or higher temperature is produced in the process of combustion of the emulsion fuel. Further, since the water-in-oil molecules or the oil-in-water molecules in the emulsion fuel have a relatively small volume, safer and more complete combustion of the emulsion fuel can be ensured.

When the stirring device 20 operates, it is preferably the blades 22 can stir all the oil-water mixture in the stirring tank 10. For this purpose, the blades 22 respectively have a lower edge located very close to the bottom in the stirring tank 10 and an outer edge located very close to an inner wall surface of the stirring tank 10, so as to effectively stir the water and the oil into an evenly mixed state.

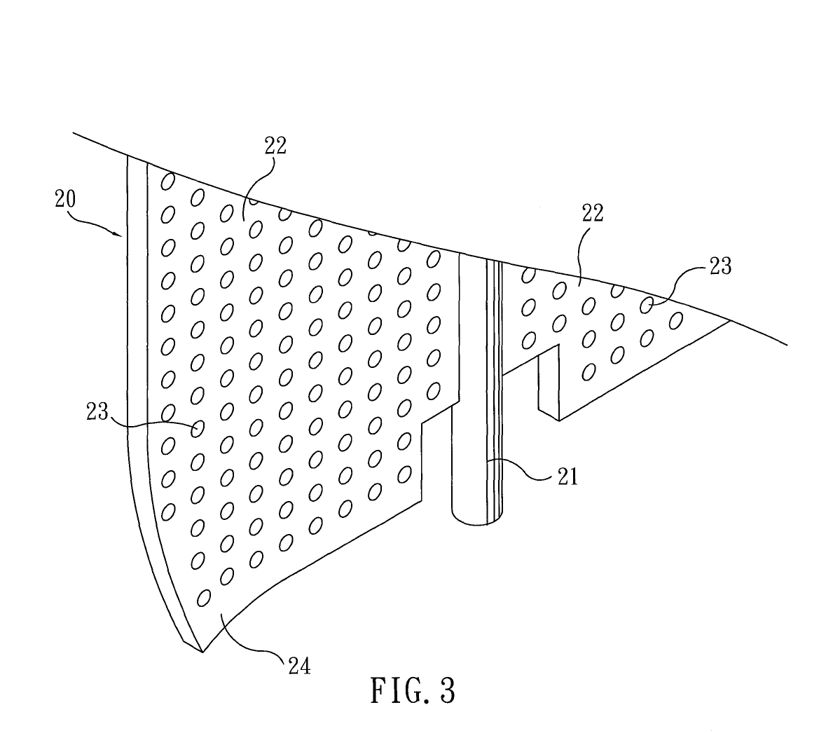

Since water has a specific gravity larger than that of oil, some part of the water supplied into the stirring tank 10 will sink to the bottom of the stirring tank 10. Meanwhile, some other part of the supplied water will be thrown toward the wall of the stirring tank 10 due to a centrifugal force during stirring. To overcome these undesirable conditions, a lower outer corner of each of the blades 22 of the stirring device 20 is formed as a spoon-like portion 24, as can be seen in FIGS. 2 and 3. The spoon-like portions 24 are protruded from one side of the blades 22 facing toward a direction in which the blades 22 rotate. With the spoon-like portions 24, water and oil near the outer edges of the blades 22 can be driven toward upper and central portions in the stirring tank 10. That is, when the stirring device 20 is driven by the motor device 13 to rotate, the spoon-like portions 24 at the lower outer corners of the blades 22 will upward push the oil-water mixture near the bottom of the stirring tank 10 for the water and the oil to fully contact and mix with each other.

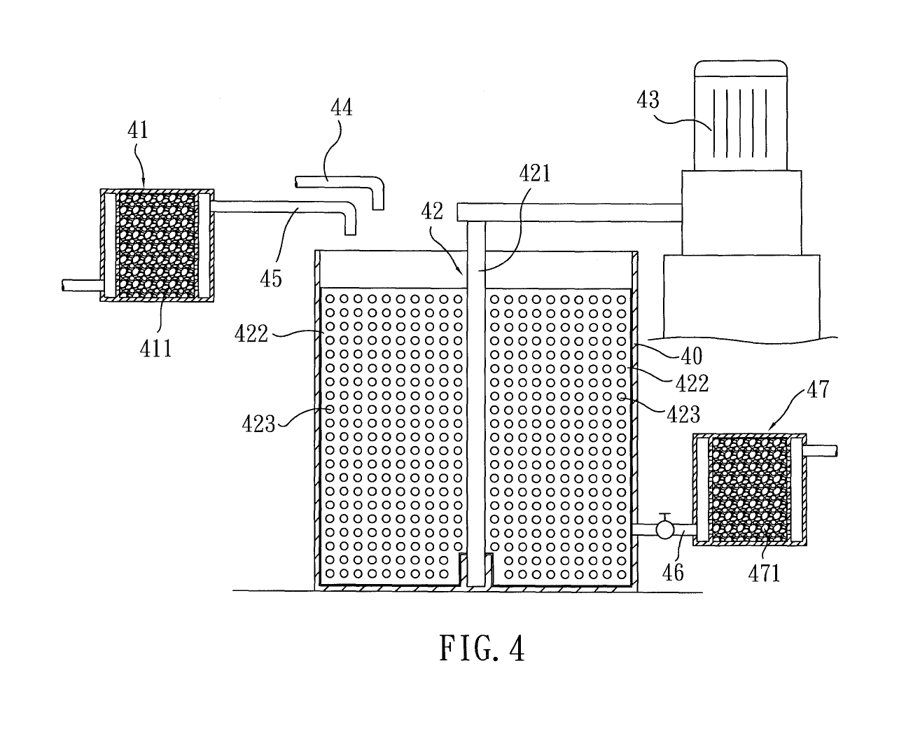

FIG. 4 shows a stirring, emulsifying and small molecule clustering apparatus for producing oil-water fuel according to a second embodiment of the present invention. In the second embodiment, the apparatus includes a stirring tank 40, a tourmaline unit 41, a stirring device 42, and a motor device 43. An oil inlet pipeline 44 and a water inlet pipeline 45 are connected to a top of the stirring tank 40 for supplying oil and water into the stirring tank 40. At least one oil-water fuel output pipeline 46 is connected to a predetermined position on a body of the stirring tank 40. The tourmaline unit 41 includes a plurality of tourmaline stones 411 capable of releasing a small amount of electric current. The tourmaline unit 41 is arranged in the water inlet pipeline 45 of the stirring tank 40. Water supplied via the water inlet pipeline 45 and flowing through the tourmaline unit 41 will be electrolyzed to cause reduction in the volume of water molecules. The tourmaline unit 41 also brings the water to contain anionic surfactants, which can emulsify the oil-water fuel, so that the oil-water fuel forms an emulsion fuel.

The stirring device 42 includes a rotary shaft 421 and at least two axially extended blades 422 connected to the rotary shaft 421. The blades 422 are angularly equally spaced around the rotary shaft 421. Each of the blades 422 is provided with a plurality of perforations 423. The motor device 43 drives the rotary shaft 421 of the stirring device 42 to rotate, so that the blades 422 connected to the rotary shaft 421 are brought to stir the oil-water fuel in the stirring tank 40.

An additional tourmaline unit 47 can be further provided in the oil-water fuel output pipeline 46 of the stirring tank 40. The additional tourmaline unit 47 includes a plurality of tourmaline stones 471 capable of releasing a small amount of electric current. With the additional tourmaline unit 47, small molecule clustering and emulsifying can be further achieved in the oil-water fuel.

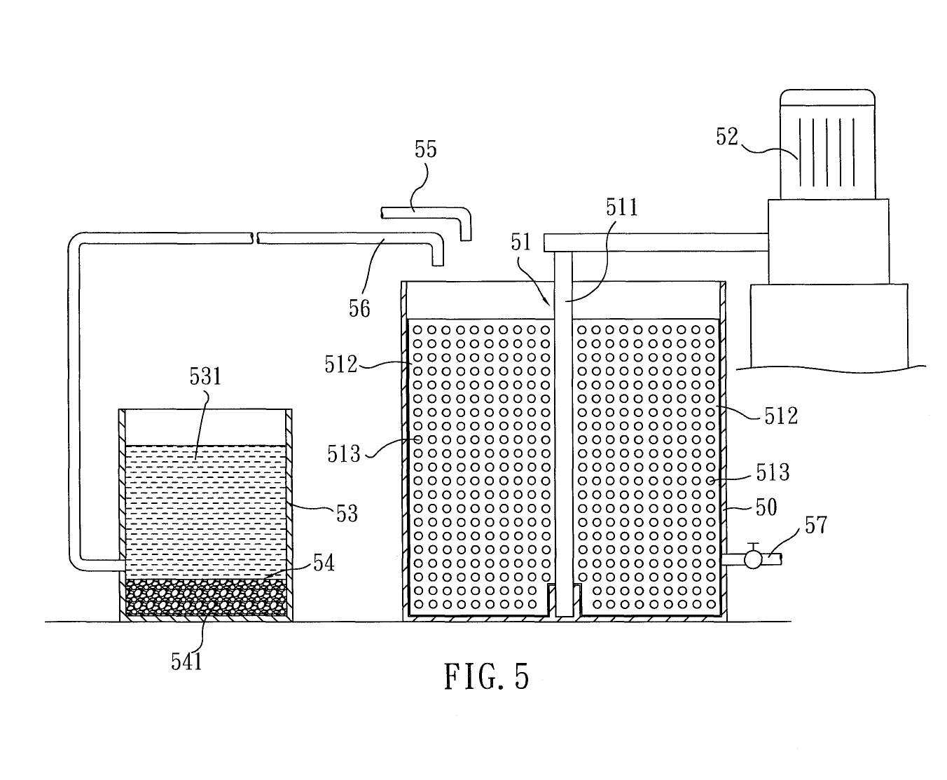

FIG. 5 shows a stirring, emulsifying and small molecule clustering apparatus for producing oil-water fuel according to a third embodiment of the present invention. In the third embodiment, the apparatus includes a stirring tank 50, a stirring device 51, a motor device 52, a water tank 53, and a tourmaline unit 54.

The stirring tank 50 is a cylindrical tank. An oil inlet pipeline 55 and a water inlet pipeline 56 are connected to a top of the stirring tank 50 for supplying oil and water into the stirring tank 50. At least one oil-water fuel outlet pipeline 57 is connected to a predetermined position on a body of the stirring tank 50. The stirring device 51 is located in the stirring tank 50, and includes a rotary shaft 511 and at least two axially extended blades 512 connected to the rotary shaft 511. The blades 512 are angularly equally spaced around the rotary shaft 511. Each of the blades 512 is provided with a plurality of perforations 513. The motor device 52 drives the rotary shaft 511 of the stirring device 51 to rotate, so that the blades 512 connected to the rotary shaft 511 are brought to stir the oil-water fuel in the stirring tank 50.

The water tank 53 is connected to the stirring tank 50 via the water inlet pipeline 56, so that water 531 stored in the water tank 53 is supplied via the water inlet pipeline 56 into the stirring tank 50. The tourmaline unit 54 is arranged in the water tank 53, and includes a plurality of tourmaline stones 541 capable of releasing a small amount of electric current.

The small amount of electric current released by the tourmaline stones 541 in the water tank 53 causes part of water molecules in the oil-water mixture to electrolyze and generate hydrogen and oxygen, bringing reduction in the volume of the water molecules. The small amount of electric current released by the tourmaline stones 541 also brings the water to contain anionic surfactants. Therefore, when the water 531 stored in the water tank 53 is supplied into the stirring tank 50 to stir and mix with the oil, the water-in-oil molecules or the oil-in-water molecules so formed would have correspondingly reduced volume to thereby achieve the purpose of forming small molecular clusters in the oil-water fuel. The anionic surfactants contained in the water 531 can emulsify the oil-water fuel, so that the oil-water fuel forms an emulsion fuel.

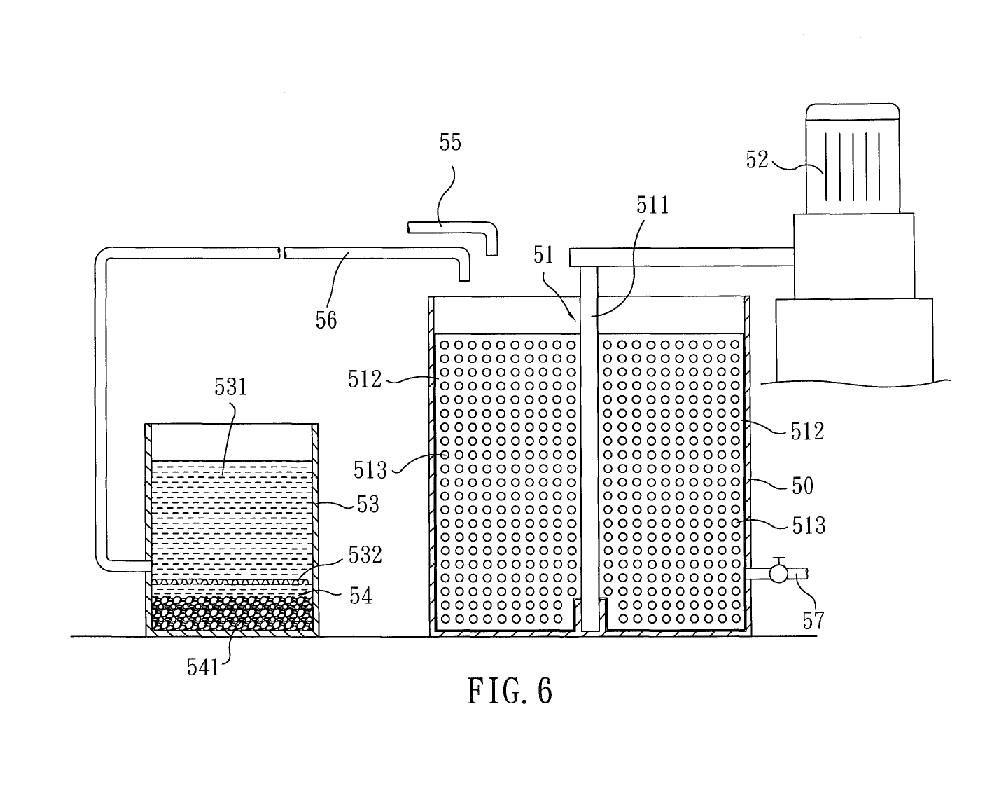

In the third embodiment illustrated in FIG. 5, the tourmaline unit 54 is immovably fixed to the bottom of the water tank 53 using cement. However, the tourmaline unit 54 can also be provided in the water tank 53 on the bottom thereof simply by letting the tourmaline stones 541 deposit on the bottom of the water tank 53, as shown in FIG. 6. In this case, a net 532 is provided above the tourmaline unit 54 to prevent the tourmaline stones 541 from moving into the water inlet pipeline 56.

The stirring, emulsifying and small molecule clustering apparatus for producing oil-water fuel according to the present invention is mainly characterized in that the stirring, emulsifying, and small molecule clustering can be done at one time in producing the oil-water fuel. Thus, the process for producing emulsion fuel with small molecular clusters can be simplified to reduce the production equipment cost, increase the productivity, and eliminate the generation of toxic gas of NOₓ. The apparatus of the present invention can be applied to gasoline, diesel oil, boiler oil, and heavy oil. Moreover, in the present invention, with the water electrolysis caused by the tourmaline stones, the reduction in the volume of the water molecules can be achieved to thereby reduce the volume of the oil-in-water or the water-in-oil molecules in the emulsion fuel, enabling more stable and safer combustion of the emulsion fuel as well as increased combustion performance.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A stirring, emulsifying and small molecule clustering apparatus for producing oil-water fuel, comprising:
a stirring tank being a cylindrical tank and having an oil inlet pipeline and a water inlet pipeline connected to a top thereof;
a tourmaline unit including a plurality of tourmaline stones capable of releasing a small amount of electric current, and being arranged in the stirring tank on a bottom thereof;
a stirring device being located in the stirring tank and including a rotary shaft and at least two axially extended blades connected to the rotary shaft; and the blades being angularly equally spaced around the rotary shaft and having a plurality of perforations formed thereon; and
a motor device for driving the rotary shaft of the stirring device to rotate, so that the blades connected to the rotary shaft are brought to stir an oil-water mixture in the stirring tank to produce oil-water fuel.

2. The apparatus as claimed in claim 1, wherein the tourmaline unit is immovably fixed to the bottom of the stirring tank using cement.

3. The apparatus as claimed in claim 1, wherein the perforations formed on each of the blades are evenly distributed on the whole blade.

4. The apparatus as claimed in claim 1, wherein the blades of the stirring device respectively have a lower outer corner formed as a spoon-like portion, and the spoon-like portions being protruded from one side of the blades facing toward a direction in which the blades rotate.

5. A stirring, emulsifying and small molecule clustering apparatus for producing oil-water fuel, comprising:
a stirring tank being a cylindrical tank, and having an oil inlet pipeline and a water inlet pipeline connected to a top thereof, and an oil-water fuel output pipeline connected to a predetermined position on a body thereof;
a tourmaline unit including a plurality of tourmaline stones capable of releasing a small amount of electric current, and being arranged in the water inlet pipeline of the stirring tank;
a stirring device being located in the stirring tank and including a rotary shaft and at least two axially extended blades connected to the rotary shaft; and the blades being angularly equally spaced around the rotary shaft and having a plurality of perforations formed thereon; and
a motor device for driving the rotary shaft of the stirring device to rotate, so that the blades connected to the rotary shaft are brought to stir an oil-water mixture in the stirring tank to produce oil-water fuel.

6. The apparatus as claimed in claim 5, further comprising an additional tourmaline unit arranged in the oil-water fuel output pipeline of the stirring tank; and the additional tourmaline unit including a plurality of tourmaline stones capable of releasing a small amount of electric current.

7. The apparatus as claimed in claim 5, wherein the perforations formed on each of the blades are evenly distributed on the whole blade.

8. The apparatus as claimed in claim 5, wherein the blades of the stirring device respectively have a lower outer corner formed as a spoon-like portion, and the spoon-like portions being protruded from one side of the blades facing toward a direction in which the blades rotate.

9. A stirring, emulsifying and small molecule clustering apparatus for producing oil-water fuel, comprising:
a stirring tank being a cylindrical tank and having an oil inlet pipeline and a water inlet pipeline connected to a top thereof;
a stirring device being located in the stirring tank and including a rotary shaft and at least two axially extended blades connected to the rotary shaft; and the blades being angularly equally spaced around the rotary shaft and having a plurality of perforations formed thereon;
a motor device for driving the rotary shaft of the stirring device to rotate, so that the blades connected to the rotary shaft are brought to stir an oil-water mixture in the stirring tank to produce oil-water fuel;
a water tank being connected to the stirring tank via the water inlet pipeline for supplying water stored in the water tank into the stirring tank; and
a tourmaline unit including a plurality of tourmaline stones capable of releasing a small amount of electric current, and being arranged in the water tank.

10. The apparatus as claimed in claim 9, wherein the perforations formed on each of the blades are evenly distributed on the whole blade.

11. The apparatus as claimed in claim 9, wherein the blades of the stirring device respectively have a lower outer corner formed as a spoon-like portion, and the spoon-like portions being protruded from one side of the blades facing toward a direction in which the blades rotate.

12. The apparatus as claimed in claim 9, wherein the tourmaline unit is immovably fixed to the bottom of the water tank using cement.
